(19) United States
(12) Patent Application Publication
(10) Pub. No.: US 2001/0043644 A1
(43) Pub. Date: Nov. 22, 2001

(54) Method of despreading a spread spectrum signal

(75) Inventors: Saul R. Dooley, Reigate (GB); Andrew T. Yule, East Grinstead (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/855,595

(22) Filed: May 15, 2001

(30) Foreign Application Priority Data
May 16, 2000 (GB) 0011761.4
Jun. 12, 2000 (GB) 0014127.5

(51) Int. Cl. H04K 1/00; H04B 15/00

(52) U.S. Cl. 375/150

(57) ABSTRACT

A method of despreading a target spread spectrum signal containing pseudorandom noise (PRN) code sequences modulated by a data message is disclosed. The method comprises the steps of providing data message information relating to the timing of an epoch of at least one data bit; and performing a correlation of the target signal and a replica signal containing corresponding PRN code sequences using the data message information to minimise degradation of the correlation caused by variations in the PRN code sequences in the target signal attributable to modulation by the data message.

The correlation may be timed so as to substantially avoid continuous correlation over an epoch of a data bit. Alternatively, the data message information may further comprise bit information wherein the correlation is modified as a function of the data message information. In particular, where data bit modulation of the PRN code sequences in the target signal is the same as or equivalent to exclusive-or modulation, the polarity of PRN code sequences in the replica signal may be selectively reversed.

This invention relates to a method of despreading spread spectrum signals containing pseudorandom noise (PRN) code sequences modulated by a data message; and to a mobile unit, a base station and a combination of a mobile unit and a base station for the same.

In particular, but not exclusively, the invention relates to a mobile cellular telephone for use in a cellular telephone network and comprising a Global Positioning System (GPS) receiver, wherein operators of the cellular telephone network are able to determine from the cellular telephone the location from which an emergency call is made.

It is well known to provide a GPS receiver in which replica GPS satellite pseudorandom noise (PRN) code signals are continuous generated and correlated with received GPS signals in order to acquire them. Typically, as the replica codes are likely to have a different code phase to those of the received GPS signals and also a different frequency due to Doppler shift between the receiver and orbiting satellites, a two dimensional code frequency/phase sweep is employed whereby such a sweep will eventually result in the incoming PRN code having the same frequency and code phase as that of the locally generated replica. If detected, the code is acquired and tracked, and the pseudorange information may be retrieved from which the position of the receiver may be calculated using conventional navigation algorithms.

It is further known to provide a mobile cellular telephone incorporating such a GPS receiver for the purpose of enabling operators of cellular telephone networks to determine the location from which a call is made and, in particular, for an emergency call to the emergency services. Of course for an emergency call, it is desirable for the call location to be available as soon as possible, however, from a “cold start” where the GPS receiver does not have access to up to date ephemeris data or even worse from a “factory cold start” where the GPS receiver does not have an up to date almanac, the time to first fix (TTFF) can be anywhere between 30 seconds and 5 minutes.

In order to reduce the TTFF, a GPS receiver may be provided with base station assistance in order to acquire GPS signals more quickly. Such assistance may include the provision by the base station to the receiver of a precision carrier frequency reference signal for calibrating the local oscillator used in the GPS receiver; the data message for up to date satellite almanac and ephemeris data from which Doppler shift for satellites in view can be determined; and the current PRN code phase. With such assistance, it is possible to sweep only a narrowed range of frequencies and code phases in which the target PRN code is known to occupy, thereby reducing the number of code instances that need to be checked and thus reducing the time for code acquisition. Base station assistance is further described in U.S. Pat. Nos. 5,841,396 and 5,874,914 which are incorporated herein by reference.

A substantial reduction in the number of code instances that need to be checked enables an increase in the dwell time for each check without significantly affecting the overall time to acquisition. The benefit of this is that an increase in the dwell time increases the probability of acquiring weak GPS signals. For example, for a single code instance, correlation may occur over a period of 5 ms, equivalent to 5 PRN code repetitions (C/A mode). Unfortunately however, in order to acquire very weak signals, one can not merely increase the dwell time indefinitely. As noted in U.S. Pat. No. 5,874,914 at lines 51 to 59 of column 11, the presence of the 50 baud data (C/A mode) superimposed on the GPS signal limits the coherent summation of PRN codes to a period of 20 ms (the data bit width) which equates to 20 PRN code repetitions. In order to acquire very weak GPS signals, it is therefore necessary to sum many individually correlations of less than 20ms. For example, as disclosed in U.S. Pat. No. 5,874,914, 100 ms to 1s worth of individual 10 ms correlation periods may be summed.

The provision of the navigation data bit information and code phase information is also disclosed in Telecom Industry Association's “TR45 Position Determination Service Standard for Dual-Mode Spread Spectrum Signals” standard at pages 4-28 and 4-38, reference TIA/EIA/IS-801 Publication Version Oct. 15, 1999.

It is an object of the present invention to provide an improved method of correlation with which the probability of acquiring weak spread spectrum signals may be increased.

According to the present invention, there is provided a method of despreading a target spread spectrum signal containing pseudorandom noise (PRN) code sequences modulated by a data message comprising the steps of providing data message information relating to the timing of an epoch of at least one data bit; and performing a correlation of the target signal and a replica signal containing corresponding PRN code sequences using the data message information to minimise degradation of the correlation caused by variations in the PRN code sequences in the target signal attributable to modulation by the data message.

The present invention is based on the realisation that degradation of a continuous correlation over a time period in which an epoch of a data bit occurs separating data bits of differing polarity is not unavoidable as would appear to be suggested by the prior art.

In one method, a correlation may be timed so as to substantially avoid continuous correlation over an epoch of a data bit, for example timed so as to occupy more than 80% but less than 100% of the data bit width between data bit epochs. In order to acquire weak signals, a correlation output may be provided as a function of the sum of correlation values returned for a series of such individual, continuous correlations. Using this method, multiple correlations, each over substantially the full data bit width are possible, e.g. 20ms each for NAVSTAR C/A mode, whilst ensuring that the correlation degradation as described above is reduced.

Alternatively, the data message information may further comprise data bit information relating to at least part of the data message wherein the correlation is modified as a function of the data message information. A continuous correlation may then occur over a time period in which an epoch of a data bit occurs separating data bits of differing polarity; or over a time period greater than the transmission period of a single data bit, or 10 or 50 times greater than the transmission period of a single data bit.

If the data bit modulation of the PRN code sequences in the target signal is the same as or equivalent to exclusive-or modulation, the polarity of PRN code sequences in the replica signal may be selectively reversed as a function of the data message information.

For example, with respect to NAVSTAR GPS, the C/A code and 50 Hz data message are combined using an exclusive-or process prior to carrier modulation. The exclusive-or process is also equivalent to a biphase shift key (BPSK) modulation process and therefore the polarity of PRN code sequences modulated by ′1's as opposed to ′0's of the data message will be opposite. As a consequence, correlation over a data message epoch will normally result in correlation of PRN code sequences modulated by ′1's as opposed to ′0's cancelling each other out. Selectively reversing the polarity of PRN code sequences in the replica signal such that it mirrors that of the PRN code sequences of the target signal may be used to avoid this possibility, and thereby reduce degradation of the correlation.

Where the pseudorandom noise (PRN) code sequences of the target spread spectrum signal are modulated by a data message which is cyclically repeated, as with NAVSTAR GPS, at least some of the data bit information is predicted based on a previous data message, especially where data message is known to be substantially constant from one message to the next.

Also, upon the identification of data bit information having a likelihood of being incorrect, alternative correlations may be performed based on possible formulations of the data bit information, for example, using the Viterbi algorithm in order to establish the most likely data bit sequence. The Viterbi algorithm is discuss in a paper entitled “The Viterbi Algorithm ” by M S Ryan and G R Nudd of the Department of Computer Science, University of Warwick (Coventry, UK) in Warwick Research Report RR238 with reference to the original papers by A J Viterbi entitled “Error Bounds for Convolution Codes and an Asymptotically Optimum Decoding Algorithm, IEEE Transactions on Information Theory”, April 1967, IT-13(2) pages 260 to 269; and “Convolution Codes and their Performance in Communications Technology”, Oct. 1971, COM-19(5) pages 751 to 772.

Equally, upon the identification of data bit information having a likelihood of being incorrect, the correlation may revert from a continuous correlation over data epochs to summing the moduli of individual correlations timed between data epochs.

The target signal may be received by a mobile unit, and the data message information provided at a base station.

Where this is so, the base station may comprise a transmitter and the mobile unit a receiver adapted for communication with the base station whereby the data message information is transmitted from the base station to the mobile unit; and wherein the correlation is performed within the mobile unit. Also, predicted data bit information may be transmitted to the mobile unit in advance of the mobile unit receiving the corresponding portion of the data message in the target signal.

In such an embodiment, the base station and the mobile unit may each comprise a transmitter and receiver adapted for two-way communication with each other; wherein the target signal is a GPS signal; and wherein position information relating to the position of the mobile unit is transmitted from the mobile unit to the base station. In particular, the mobile unit may be a mobile cellular telephone and the base station is one of a plurality of such base stations used in a cellular telephone network and situated at respective geographical locations to define a corresponding plurality of overlapping service areas constituting one or more regions.

Alternatively, the base station may comprise a receiver and the mobile unit comprises a transmitter adapted for communication with the base station, and wherein the target signal received by the mobile unit is transmitted to the base station. Ideally, the correlation is performed at the base station.

As an alternative to providing the data message information from a base station, the data message information may be provided from another spread spectrum signal which has already been received and acquired at the mobile unit (hereafter “the reference signal”). For example, the data message information relating to the timing of an epoch of at least one data bit of the target signal may be derived from or approximated to the timing of an epoch of at least one data bit of the reference signal. Similarly, where the data message information further comprises data bit information relating to at least part of the data message of the target signal, this may be derived from or approximated to corresponding data bit information of the reference signal. Also, to further improve the chance of acquiring weak signals, the dwell time for each code check made whilst attempting to acquiring the target signal may be greater than that previously used to acquire the reference signal.

Where both the target signal and reference signal are GPS spread spectrum signals, compensation may be made for delays affecting the timing of epochs of data bits in the target signal compared to those of the reference signal which are attributable to GPS Space Vehicles (SV)s being differing distances from the mobile unit, for example, using GPS ephemeris or almanac data.

Such a method is particularly useful for obtaining a position fix from GPS satellites where only signals from three or less GPS SVs are received relatively strongly (four signals normally being required for a position fix). Once the relatively strong signals have been acquired, information derived from such signals can then be used to assist acquisition of weaker GPS signals, thereby enabling at least four GPS satellite signals to be acquired and hence obtain a position fix.

Also provided for implementing such a method of the present invention is a mobile unit as claimed in claims 29 to 42; a base station as claimed in claims 43 to 50; and a combination of a base station and a mobile unit as claimed in claims 51 to 53.

The above and other features and advantages of the present invention will be apparent from the following description, by way of example, of an embodiment of a mobile cellular telephone comprising a GPS receiver for use in a cellular telephone network with reference to the accompanying drawings in which:

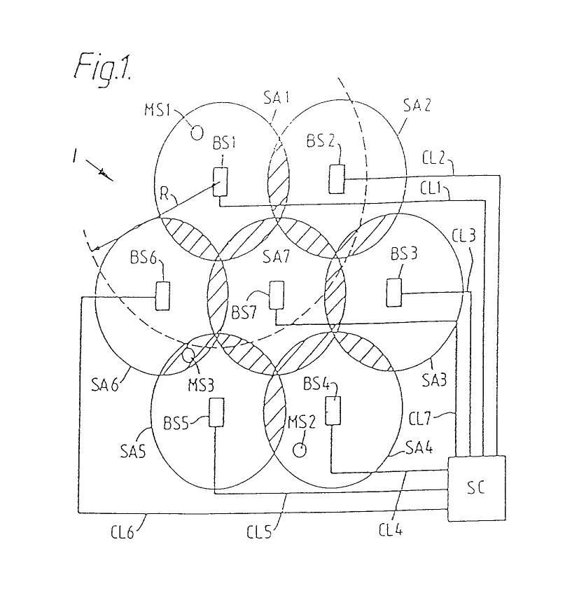

FIG. 1 shows, schematically, the geographic layout of a cellular telephone network;

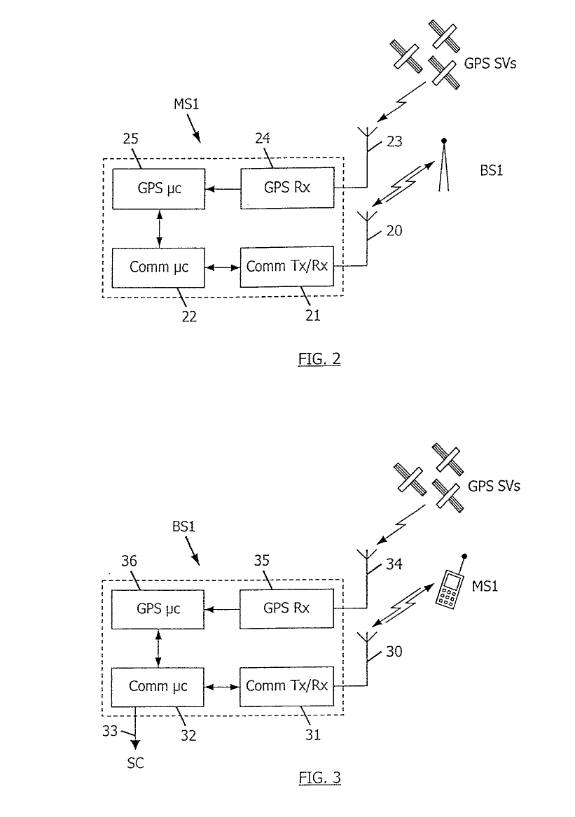

FIG. 2 shows, schematically, the mobile cellular telephone MS1 of FIG. 1 in greater detail;

FIG. 3 shows, schematically, the base station BS1 of FIG. 1 in greater detail;

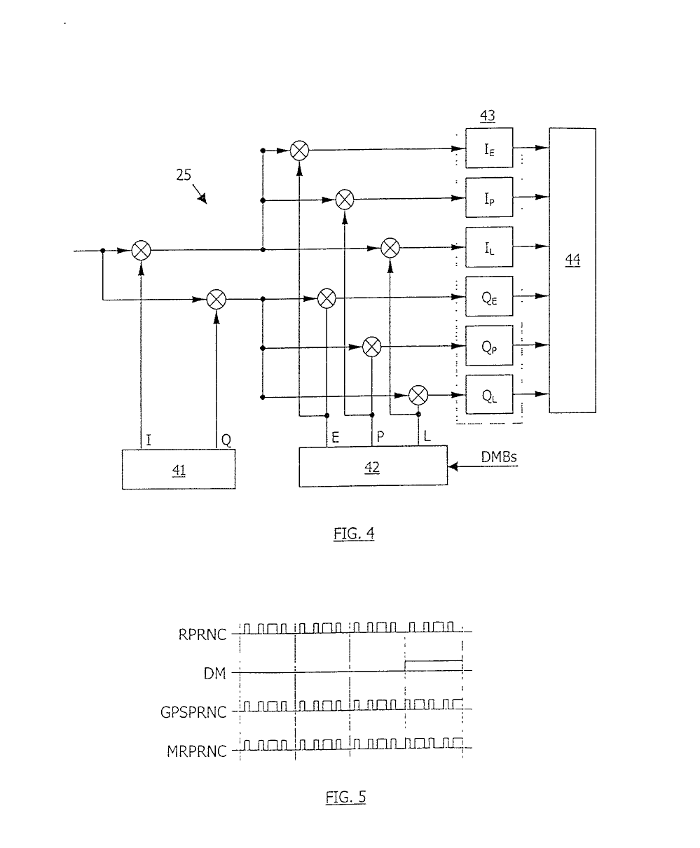

FIG. 4 shows, schematically, code acquisition by early-late correlation in the GPS microprocessor of the mobile cellular telephone MS1 of FIG. 2 in greater detail; and

FIG. 5 illustrates code correlation by methods according to the present invention.

The geographical layout of a conventional cellular telephone network 1 is shown schematically in FIG. 1. The network comprises a plurality of base stations BS of which seven, BS1 to BS7, are shown, situated at respective, mutually spaced geographic locations. Each of these base stations comprises the entirety of a radio transmitter and receiver operated by a trunking system controller at any one site or service area. The respective service areas SA1 to SA7 of these base stations overlap, as shown by the cross hatching, to collectively cover the whole region shown. The system may furthermore comprise a system controller SC provided with a two-way communication link, CL1 to CL7 respectively, to each base station BS1 to BS7. Each of these communication links may be, for example, a dedicated land-line. The system controller SC may, furthermore, be connected to a the public switched telephone network (PSTN) to enable communication to take place between a mobile cellular telephone MS1 and a subscriber to that network. A plurality of mobile cellular telephones MS are provided of which three, MS1, MS2 and MS3 are shown, each being able to roam freely throughout the whole region, and indeed outside it.

Referring to FIG. 2, mobile cellular telephone MS1 is shown in greater detail comprising a communications transmitter (Comm Tx) and receiver (Comm Rx) 21 connected to a communications antenna 20 and controlled by a communications microprocessor (Comm μc) 22 for communication with the base station BS1 with which it is registered. As the operation of such a telephone for two-way communication with a base station BS1 is entirely conventional, it will not be elaborated upon here further.

In additional to the conventional workings of a mobile telephone, telephone MS1 further comprises a GPS receiver (GPS Rx) 24 connected to a GPS antenna 23 and controlled by a GPS microprocessor (GPS μc) 25 receiving GPS spread spectrum signals transmitted from orbiting GPS satellites. When operative, the GPS receiver 24 may receive NAVSTAR SPS GPS signal through an antenna 23 and pre-process them, typically by passive bandpass filtering in order to minimise out-of-band RF interference, preamplification, down conversion to an intermediate frequency (IF) and analog to digital conversion. The resultant, digitised IF signal remains modulated, still containing all the information from the available satellites, and is fed into a memory of the GPS microprocessor 25. The GPS signals may then be are acquired and tracked for the purpose of deriving pseudorange information from which the position of the mobile telephone can be determined using conventional navigation algorithms. Such methods for GPS signal acquisition and tracking are well known, for example, see chapter 4 (GPS satellite signal characteristics) & chapter 5 (GPS satellite signal acquisition and tracking) of GPS Principles and Applications (Editor, Kaplan) ISBN 0-89006793-793-7 Artech House. The GPS microprocessor 25 may be implemented in the form a general purpose microprocessor, optionally common with the communications microprocessor 22, or a microprocessor embedded in a GPS application specific integrated circuit (ASIC).

Cellular telephone network base station BS1 is shown schematically in FIG. 3. In additional to the conventional workings associated with such a base station, it further comprises a GPS antenna 34, receiver 35 and microprocessor 36 which are in substantially continual operation whereby the base station is in constant possession of up to date GPS satellite information. This information includes which of the orbiting satellites are presently in view (such satellites are likely to be common to both telephone and associated base station for even macrocells, obscuration aside); and GPS data messages containing an almanac, ephemeris and code phase information.

As is known, in the event of the user of the mobile cellular telephone MS1 making an emergency call and under the control of the system controller SC via a two-way communication link CL1, the base station BS1 may provide this information to the telephone whereby it is then only required to sweep a narrowed range of frequencies and code phases in which the target PRN code is known to occupy, ensuring rapid code acquisition and TTFF. This information is then transmitted back to the base station from the telephone, and then on to the emergency services operator, termed the Public Safety Answer Point (PSAP) in the US.

Referring to FIG. 4, the GPS microprocessor 25 of the telephone MS1 is shown schematically implementing a pseudorandom noise (PRN) code tracking loop in which early (E), prompt (P) and late (L) replica codes of satellite PRN codes are continuously generated, and compared to the incoming satellite PRN codes as received by the receiver. In order to retrieve pseudorange information from the signal samples stored in the GPS microprocessor 25 , a carrier wave must be removed and this is done by the receiver generating in-phase (I) and quadrature phase (Q) replica carrier wave signals using a carrier wave generator 41. A carrier wave phase lock loop (PLL) is normally employed to accurately replicate the frequency of the received carrier wave. In order to acquire code phase lock, early (E), prompt (P) and late (L) replica codes of the PRN sequences are continuously generated by a code generator 42. In accordance with the present invention, the polarity of the PRN code sequences may be selectively reversed depending on the polarity of the associated data message bits (DMBs) provided by the communications microprocessor 22 to the code generator 42 of the GPS microprocessor 25. The data message bit modulated replica codes are then correlated with the I and Q signals to produce three in-phase correlation components (IE, IL, IP) and three quadrature phase correlation components (QE, QL, QP), typically by integration in an integrator 43 over many PRN code sequences and over at least one data epoch. A code phase discriminator is calculated as a function of the correlation components and a threshold test applied to the code phase discriminator; a phase match is declared if the code phase discriminator is high and if not, the code generator produces the next series of replicas with a phase shift. A linear phase sweep will eventually result in the incoming PRN code being in phase with that of the locally generated replica and thus code acquisition.

Where the GPS data is received at the base station and provided to the mobile cellular telephone in real-time, a delay in provision of the data bit information may occur. In practice, this is not a major problem as the delay can be kept relatively small, in the order of a few microseconds compared to the 20 ms data bit length. Also, as long as the position of the bit edge is known, any inversion need not be done until the end of the bit period. Indeed the results of integrating of several bit periods could be stored separately and only combined when the data bits are known.

Alternatively, in order to provide a code phase discriminator, the moduli of many individual correlations from epoch to epoch may to summed whereby such a method would not require the data message bit modulation of the replica codes.

Methods of correlation according to the present invention are illustrated in FIG. 5 using a PRN code of 12 chips representing the code “010010110100”. Of course, an actual GPS C/A signal contains PRN code sequences of 1023 chips in length.

Referring to FIG. 5: RPRNC refers to a repetition of four Replica PRN Code sequences in an unmodulated form whereby the four sequences are each normally orientated as would be generated in a conventional GPS microprocessor; DM refers to the Data Message having a data bit width longer (e.g. 8 times longer) that the PRN code sequences and in which an data bit epoch occurs precisely (for illustration) between the third and fourth PRN code sequences; GPSPRNC refers to four PRN code sequences as would be sent by a GPS SV wherein the first three PRN code sequences are modulated by the same satellite data message bit of polarity ‘0’ (thus remaining the same) and the fourth PRN code sequence is modulated by the next data message bit having a polarity ‘1’, thus having the effect of inverting the fourth PRN code sequence; and MRPRNC refers to replica PRN code sequences as modulated by the data message, and as would be generated in the telephone of the present invention having received the data message from the base station.

Conventionally, individual continuous correlations, each spanning approximately half the data width, are summed to provide a correlation output with which to determine whether the PRN code has been acquired or not. In the illustration of FIG. 5, this equates to four 4 PRN code sequences and for a continuous correlation between a received GPS PRN code (GPSPRNC) signal and a convention replica PRN code (RPRNC) signal over the four PRN code sequences, the correlation output is 2. This is because the correlation of the fourth PRN code sequence is −1, in effect cancelling out one of the matching PRN code sequences.

In accordance with the present invention, if individual continuous correlations were conducted only between data epochs and the moduli summed, the correlation output would be 4. This is derived from a value of 3 provided from a first continuous correlation to the data epoch, i.e. over the first 3 PRN code sequences, and a the moduli of −1 provided from a second correlation over the fourth PRN code sequence.

Even where compensation is made for possible errors in the timing of the data epoch such that say only 90% of the data bit width is correlated, i.e. leaving a 5% margin either side of an epoch which equates to 40% of a PRN code sequence, the correlation output would be 2.6+0.6=3.2.

Alternatively, where the data message is provided to the telephone by the base station, a continuous correlation may be done spanning a data epoch by comparing the received GPS PRN codes with a replica PRN code (MRPRNC) modulated by the data message received from the base station. In the above example, for a continuous correlation over the four PRN code sequences, the correlation output is 4.

The above of course assumes a perfect correlation which in practice does not occur and not all of the theoretical benefit will be realised, however, the improved correlation and in particular the ability to coherently sum represents a significant improvement.

Despreading a signal in a mobile unit may be done in real time or by sampling the incoming spread spectrum signal and storing the samples in a memory for subsequent processing, termed taking a “snapshot” in the parlance of Krasner in U.S. Pat. Nos. 5,663,734, 5,841,396 and 5,874,914. The later is particularly convenient with respect to a GPS receiver where the data message information is provided from a GPS spread spectrum signal which has already been received and acquired at the GPS receiver, and the target signal is another, weaker GPS signal which would normally be difficult to acquire, let alone track.

In such an arrangement, it should be noted that the data messages transmitted by different NAVSTAR GPS satellites differ slightly because part of the message is concerned with individual SV parameters, e.g. clock correction terms and ephemeris. Fortunately, however, at least the first 1.2s of data of subframes 1 to 3 and all of subframes 4 and 5 of the NAVSTAR GPS data message are common to each SV, which equates to greater than 50% of the data message, and they are of course synchronised. Therefore, by taking six consecutive 1s samples, one could record raw GPS data, i.e. take a snapshot, at a time when it was known that each satellite was broadcasting the same part of the data message

Similarly, if an accurate clock was available to the GPS receiver, one could determine which subframe was currently being transmitted by the GPS SVs by subtracting GPS zero time from the current time, and take a snapshot accordingly. The provision of data message information relating to the timing of an epoch of at least one data bit of the target signal and/or to at least part of the data message may then come from the same satellite. For example, a previously received and acquired GPS signal which has been subsequently lost may act as a reference whilst attempting to reacquire the “same signal”. In effect, the target signal would be a subsequent signal transmission of the reference signal, preferable spaced apart my an integer multiple of the 30s NAVSTAR GPS data message time period. This would be particularly useful in a situation where the received signal strength is fluctuating, for example when moving in an urban environment where at one instant a clear view of a given SV is observed, and at a later instant, the SV is obscured and as such the signal from that SV much weaker.

Alternatively, with respect to the current civilian signal and proposed additional civilian signals which are envisaged as having the same data message structure, one may act as a reference signal for the other.

Further NAVSTAR GPS data message information can be found in the ARINC NAVSTAR space segment/user interface document version IRN-200C-002. Of course, although the message format would be different, the same principle would apply to other satellite navigation systems such as GLONASS and Galileo whereby the sampling strategy would be determined according to the likelihood of repetition of particular bit sequences in the corresponding data messages and the likelihood of multiple satellites transmitting the same bit sequence in their data messages, in much the same way as has been explained for GPS.

As indicated above, the target signal may alternatively be received by the mobile unit and retransmitted to the base station for correlation. Such uploading and central processing of GPS data is known from U.S. Pat. No. 5,119,102 which is incorporated herein by reference. This arrangement, it may be necessary to time stamp the retransmitted signals in order to relate it with the data epoch timing information.

Furthermore, as an alternative to the early-late correlation method, fast convolution methods and in particular, involving Fast Fourier Transforms (FFTs), may be used in order to acquired the PRN codes. Such convolution methods are described in a paper entitled “FFT processing of direct sequence spreading codes using modern DSP microprocessors ” by Robert G Davenport, IEEE 1991 National Aerospace and Electronics Conference NAECON 1991, volume 1, pages 98 to 105, and also in U.S. granted Pat. No. 5,663,734. The method of the present invention is equally is applicable such convolution methods.

In so far as providing a data message modulated replica PRN code for correlation with the received PRN code signal is concerned, NAVSTAR GPS exclusively relates to BPSK modulation but the invention would equally apply to other forms of modulation such as phase and frequency modulation.

From a reading of the present disclosure, other modifications will be apparent to the skilled person skilled and may involve other features which are already known in the design, manufacture and use of GPS receivers and component parts thereof and which may be used instead of or in addition to features already described herein. Although claims have been formulated in this application to particular combinations of features, it should be understood that the scope of the disclosure of the present application also includes any novel feature or any novel combination of features disclosed herein either explicitly or implicitly, whether or not it relates to the same invention as presently claimed in any claim and whether or not it mitigates any or all of the same problems as does the present invention. The applicants hereby give notice that new claims may be formulated to such features and/or combinations of such features during the prosecution of the present application or of any further application derived therefrom.

1. A method of despreading a target spread spectrum signal containing pseudorandom noise (PRN) code sequences modulated by a data message comprising the steps of:
providing data message information relating to the timing of an epoch of at least one data bit of the target signal; and
performing a correlation of the target signal and a replica signal containing corresponding PRN code sequences using the data message information to minimise degradation of the correlation caused by variations in the PRN code sequences in the target signal attributable to modulation by the data message.

2. A method according to claim 1 wherein the correlation is timed so as to substantially avoid continuous correlation over an epoch of a data bit.

3. A method according to claim 2 wherein the correlation is timed so as to occupy more than 80% but less than 100% of the data bit width.

4. A method according to claim 2 or claim 3 wherein a correlation output is provided as a function of the sum of correlation values returned for a series of individual, continuous correlations.

5. A method according to claim 1 wherein the data message information further comprises data bit information relating to at least part of the data message; and wherein the correlation is modified as a function of the data message information.

6. A method according to claim 5 wherein a continuous correlation occurs over a time period in which an epoch of a data bit occurs separating data bits of differing polarity.

7. A method according to claims 5 or 6 wherein a continuous correlation occurs over a time period greater than the transmission period of a single data bit.

8. A method according to claim 7 in which continuous correlation occurs over a time period 10 times greater than the transmission period of a single data bit.

9. A method according to claim 8 in which continuous correlation occurs over a time period 50 times greater than the transmission period of a single data bit.

10. A method according to any of claims 5 to claim 9 wherein data bit modulation of the PRN code sequences in the target signal is the same as or equivalent to exclusive-or modulation; and wherein the polarity of PRN code sequences in the replica signal is selectively reversed as a function of the data message information.

11. A method according to any of the preceding claims wherein pseudorandom noise (PRN) code sequences of the target spread spectrum signal are modulated by a data message, at least part of which is cyclically repeated, and wherein at least some of the data bit information is predicted based on a previous data message.

12. A method according to claim 11 wherein data bit information based on a previous data message is known to be substantially constant from one message to the next.

13. A method according to claim 12 wherein upon the identification of data bit information having a likelihood of being incorrect, alternative correlations are performed based on other possible formulations of the data bit information.

14. A method according to claim 13 wherein the viterbi algorithm is used in order to establish the most likely data bit sequence.

15. A method according to claim 14 wherein upon the identification of data bit information having a likelihood of being incorrect, the correlation reverts from a continuous correlation over data epochs to summing the moduli of individual correlations timed between data epochs.

16. A method according to any of the preceding claims wherein the target signal is a GPS signal and is received by a mobile unit; and wherein the data message information is provided from another GPS spread spectrum signal which has already been received and acquired at the mobile unit (hereafter “the reference signal”).

17. A method according to claim 16 wherein the data message information relating to the timing of an epoch of at least one data bit of the target signal is derived from the timing of an epoch of at least one data bit of the reference signal.

18. A method according to claim 17 wherein the data message information relating to the timing of an epoch of at least one data bit of the target signal is derived from the timing of an epoch of at least one data bit of the reference signal using GPS ephemeris data.

19. A method according to any of claims 16 to 18 wherein the dwell time for each code check made whilst attempting to acquiring the target signal is greater than that previously used to acquire the reference signal.

20. A method according to any of claims 16 to 19 wherein the data message information further comprises data bit information relating to at least part of the data message of the target signal which is derived from corresponding data bit information of the reference signal.

21. A method according to any of claims 1 to 15 wherein the target signal is received by a mobile unit, and the data message information is provided at a base station.

22. A method according to claim 21 wherein the base station comprises a transmitter and the mobile unit comprises a receiver adapted for communication with the base station whereby the data message information is transmitted from the base station to the mobile unit; and wherein the correlation is performed within the mobile unit.

23. A method according to claim 22 wherein predicted data bit information is transmitted to the mobile unit in advance of the mobile unit receiving the corresponding portion of the data message in the target signal.

24. A method according to claim 22 or claim 23 wherein the base station and the mobile unit each comprise a transmitter and a receiver adapted for two-way communication with each other; wherein the target signal is a GPS signal; and wherein position information relating to the position of the mobile unit is transmitted from the mobile unit to the base station.

25. A method according to claim 24 wherein the mobile unit is mobile cellular telephone and the base station is one of a plurality of such base stations used in a cellular telephone network and situated at respective geographical locations to define a corresponding plurality of overlapping service areas constituting one or more regions.

26. A method according to claim 21 wherein the base station comprises a receiver and the mobile unit comprises a transmitter adapted for communication with the base station, and wherein the target signal received by the mobile unit is transmitted to the base station.

27. A method according to claim 26 wherein the correlation is performed at the base station.

28. A method of despreading a target spread spectrum signal containing pseudorandom noise (PRN) code sequences modulated by a data message as hereinbefore described with reference to the accompanying figures.

29. A mobile unit for despreading a spread spectrum signal by a method according to claims 16 to 20 and claims 22 to 25.

30. A mobile unit comprising a receiver for receiving a target spread spectrum signal containing pseudorandom noise (PRN) code sequences modulated by a data message, and a signal containing data message information relating to the timing of an epoch of at least one data bit; and a processor for generating a replica signal containing PRN code sequences corresponding to those of the target signal and performing a correlation of the target signal and the replica signal; wherein the data message information is used to reduce degradation of the correlation caused by variations in the PRN code sequences in the target signal attributable to modulation by the data message.

31. A mobile unit according to claim 30 wherein the correlation is timed so as to substantially avoid continuous correlation over an epoch of a data bit.

32. A mobile unit according to claim 31 wherein a correlation output is provided as a function of the sum of correlation values returned for a series of individual, continuous correlations.

33. A mobile unit according to claim 30 wherein the data message information further comprises data bit information relating to at least part of the data message, and wherein the correlation is modified as a function of the data message information.

34. A mobile unit according to claim 33 wherein a continuous correlation occurs over a time period in which an epoch of a data bit occurs separating data bits of differing polarity.

35. A mobile unit according to claim 33 or claim 34 wherein data bit modulation of the PRN code sequences in the target signal is the same as or equivalent to exclusive-or modulation; and wherein the polarity of PRN code sequences in the replica signal is selectively reversed as a function of the data message information.

36. A mobile unit according to any of claims 30 to 35 wherein the data message information is provided from another spread spectrum signal which has already been received and acquired at the mobile unit (hereafter “the reference signal”).

37. A mobile unit according to claim 37 wherein the data message information relating to the timing of an epoch of at least one data bit of the target signal is derived from the timing of an epoch of at least one data bit of the reference signal.

38. A mobile unit according to claim 37 in the form of a GPS receiver wherein the target signal is a GPS signal; and wherein the data message information relating to the timing of an epoch of at least one data bit of the target signal is derived from the timing of an epoch of at least one data bit of the reference signal and GPS ephemeris data.

39. A mobile unit according to any of claims 36 to 38 wherein the dwell time for each code check made whilst attempting to acquiring the target signal is greater than that previously used to acquire the reference signal.

40. A mobile unit according to any of claims 36 to 39 wherein the data message information further comprises data bit information relating to at least part of the data message of the target signal which is derived from corresponding data bit information of the reference signal.

41. A mobile unit according to claim 30 to 35 in the form of a cellular telephone for use with a cellular telephone network and comprising a GPS receiver, wherein the signal containing data message information is provided from a cellular telephone network base station.

42. A mobile unit for despreading a target spread spectrum signal containing pseudorandom noise (PRN) code sequences modulated by a data message as hereinbefore described with reference to the accompanying figures.

43. A base station for despreading a spread spectrum signal by a method according to claim 27.

44. A base station comprising a receiver for receiving from a mobile unit a target spread spectrum signal containing pseudorandom noise (PRN) code sequences modulated by a data message received by the mobile unit, means for providing data message information; and a processor for generating a replica signal containing PRN code sequences corresponding to those of the target signal and performing a correlation of the target signal and the replica signal; wherein the data message information is used to reduce degradation of the correlation caused by variations in the PRN code sequences in the target signal attributable to modulation by the data message.

45. A base station according to claim 44 wherein the correlation is timed so as to substantially avoid continuous correlation over an epoch of a data bit.

46. A base station according to claim 45 wherein a correlation output is provided as a function of the sum of correlation values returned for a series of separate, continuous correlations.

47. A base station according to claim 44 wherein the data message information further comprises data bit information relating to at least part of the data message, and wherein the correlation is modified as a function of the data message information.

48. A base station according to claim 47 wherein a continuous correlation occurs over a time period in which an epoch of a data bit occurs separating data bits of differing polarity.

49. A base station according to claim 47 or claim 48 wherein data bit modulation of the PRN code sequences in the target signal is the same as or equivalent to exclusive-or modulation; and wherein the polarity of PRN code sequences in the replica signal is selectively reversed as a function of the data message information.

50. A base station for despreading a target spread spectrum signal containing pseudorandom noise (PRN) code sequences modulated by a data message as hereinbefore described with reference to the accompanying figures.

51. The combination of a mobile unit according to any of claims 30 to 35 and a base station, wherein the target signal is received by the mobile unit, and the data message information is provided at a base station.

52. The combination of a mobile unit and a base station according to any of claims 44 to 50.

53. A combination of a mobile unit and a base station for despreading a target spread spectrum signal containing pseudorandom noise (PRN) code sequences modulated by a data message as hereinbefore described with reference to the accompanying figures.
